(19) United States
(12) Patent Application Publication
(10) Pub. No.: US 2026/0321036 A1
(43) Pub. Date: Oct. 15, 2026

(54) METHOD AND DEVICE FOR SPATIAL ANALYSIS OF BIOLOGICAL SAMPLES

(71) Applicant: Carl Zeiss Microscopy GmbH, Jena (DE)

(72) Inventors: Moritz WIDMAIER, München (DE); Maciej BUCKI, Breda (NL); Laura PILGER, München (DE); Florian LEISS, München (DE)

(73) Assignee: Carl Zeiss Microscopy GmbH, Jena (DE)

(21) Appl. No.: 19/641,966

(22) Filed: Apr. 8, 2026

(30) Foreign Application Priority Data
Apr. 10, 2025 (DE) 10 2025 114 149.5

(51) Int. Cl. G06V 20/69; G01N 1/30; G01N 1/31; G06V 10/96; G06V 10/98

(52) U.S. Cl. CPC G06V 20/698; G01N 1/31; G06V 10/96; G06V 10/993; G01N 2001/302; G06V 2201/03

(57) ABSTRACT

A computer-implemented method for spatial analysis of stained biological samples. The method involves: identifying a sample, selecting an analysis routine from a plurality of analysis routines for the identified sample, each subroutine comprising parameters of a scanning process in which at least one image of the entire sample is recorded, and parameters of an image analysis of the recorded images, and applying the subroutines of the selected analysis routine to the identified sample. The entire sample is scanned when each subroutine is applied. The recorded images are evaluated according to the parameters of the image analysis, for registering the images.

### The invention relates to a method and to a device for spatial analysis of stained biological samples, and to a corresponding computer program.

Spatial biology tissue analysis is a promising tool in histopathology and could replace a large part of the established routine procedures, which are based upon chromogenic staining of thin tissue sections and visual analysis by trained experts. However, the application of fluorescence-based staining techniques in general, and the use of cyclic fluorescence-based staining techniques in particular, makes the entire workflow of scanning and analyzing slides significantly more complex, and there are no established methods that allow for controlled and automated routine application.

Rather, it is necessary to correctly perform the following steps in sequence:
i. Correctly configuring the microscope for scanning the slide by making the correct settings for imaging, including selecting and adjusting the filters to be used, the light sources, the exposure times, the contrast, e.g., capturing a high-contrast image or HDR image (HDR: high dynamic range), and specifying the required metadata for later analysis, e.g., file name, sample name, test/assay name, names of the stained markers per channel;
ii. Rapidly scanning the entire slide surface at low resolution as an overview image (pre-scan), optionally with additional steps to identify, for example, the region of the slide that needs to be scanned at higher resolution and as a fluorescence image. One reason for this is that the acquisition of the detail image as a fluorescence image is relatively slow and is therefore to be carried out only in regions where sample portions of interest, e.g., tissue, are located. Another reason for this is that, when planning the scanning process for the detail image, it should be determined where the automatic focus is to be applied, which also only works well if there is actually tissue present at that point.
iii. Capturing the detail image (sample scan); the alignment of the coordinates of the pre-scan and sample scan is achieved via the positioning of the microscope stage.
iv. Examining the captured detail image and documenting the success or failure of the imaging and staining process;
v. If cyclic staining and imaging routines are used, repeat steps i to iv for successive staining and imaging sequences and identify all images belonging to the same tissue section, and execute a (co-)registration algorithm to generate a new, uniform, and aligned image from the individual images, in which case the co-registration must be based upon identical image features of the fluorescence staining in a similarly stained channel (usually DAPI for cell nuclei) to achieve the highest registration accuracy;
vi. Importing the resulting images into a suitable software environment for running quantitative image analysis algorithms and selecting the correct analysis algorithm to obtain analysis results. This step is further complicated by the combinatorial complexity of multiplex immunofluorescence (mIF)-based assays, which often combine a limited number of markers, typically in the lower triple-digit range, into multiplex images, of which 3 to 50 are used for a single multiplex image. For this reason, either a large number of specialized algorithms must be provided, or alternatively, an algorithm must be provided that combines the results of analysis algorithms that specialize in analyzing individual markers or groups of similar markers.
vii. Documenting the progress and results of the workflow.

Due to the many manual steps, the overall process described is slow, labor-intensive, and leads to results that vary greatly depending upon the user, or are often even incorrect. An additional difficulty is the correct setting, especially of the exposure parameters, for the different staining rounds, because the staining intensities can change greatly depending upon the stained markers, but also due to variability in the samples that is difficult to control. Therefore, its application in routine histopathology is hardly possible at present.

Methods for automating scanning processes are already known from the prior art. For example, U.S. Pat. No. 11,656,446 B2 describes a method for capturing a high-resolution scan of a biological sample arranged on a substrate. The method involves the following: receiving an initial user input on a graphical user interface corresponding to the user-configurable scan settings, receiving a second user input on a graphical user interface to start the scanning process based upon the initial user input, and displaying a visualization of one or more placeholders on the graphical user interface that are filled with information about the status of the scanning process, image data, and at least some of the user-configurable scan settings. The method uses preview images, based upon which a region of interest can be selected and a high-resolution image taken from it. Scan settings can be varied based upon slide information, such as barcodes.

From U.S. Pat. No. 10,746,751 B2, a device is known which comprises an imaging module with a microscope, a storage module, and an automated transport module for transporting a slide between the imaging module and the storage module. The slide features an identifier designed to store information regarding a desired imaging protocol and a processing protocol. A control system manages the transport of the slide using the transport module and the image recording, which is based upon the information stored in the identifier. The associated method involves the following steps: reading an identifier on at least one slide, automatically determining whether an imaging module is available for imaging a biological sample on the at least one slide, transporting the slide to the imaging module using an automated transport module if the imaging module is found to be available, acquiring an electronic image of part of the biological sample, and transporting the slide to a storage module using the automated transport module if the imaging module is found to be unavailable. Optionally, the slide can be processed, e.g., stained, before being transported to the imaging module. Additional or different testing procedures or staining protocols may be performed if an examination of the sample image reveals that further imaging is required.

U.S. Pat. No. 8,315,445 B2 describes a method and device for identifying microscope slides, wherein samples, such as tissue samples, arranged on microscope slides are labeled with information, and an image of the information is captured by a processing instrument. The image is analyzed, e.g., with optical character recognition, and the information extracted from the image is used to determine the test, e.g., staining, to be performed by the processing instrument on the slide. If information about the slide cannot be extracted from the image, the image is presented to a user so that they can select the relevant information.

U.S. Pat. No. 7,829,868 B2 discloses a method for automated microscopic analysis of biological samples. In this method, data contained on a slide on which the sample is arranged are electronically queried, and from this it is determined how the sample should be scanned with an automated microscope. An associated log can optionally be retrieved from a database. The sample is then scanned accordingly and the result is evaluated. The method can also be used for high-throughput analysis.

EP 1 994 398 B1 describes a method and a device for the automated digitization of microscope slides which have one or more regions with a sample and at least one separate region with an information field. The method uses a digital image recording system that includes a slide holder, a mechanism for its operation, a first digital image recording device, a second digital image recording device with high magnification, and a control unit for software-based control of the automated image recording. The first digital image recording device is suitable for reading out at least one region comprising the information field and includes a digital preview camera that separately captures a low-resolution preview image of each region with sample. The control unit is equipped with a routine for searching for points of the low-resolution preview images that belong to the sample.

US 2003/023791 A1 describes a method for automating the scanning process of FISH/RNA-scope stained samples, including mIF (multiplex immunofluorescence) stained samples. Particular attention is paid here to limiting the very slow scanning process using 40× or higher resolution lenses to a few interesting sub-regions in the tissue. For this purpose, parallel sections are scanned relatively quickly using brightfield staining, and interesting regions are identified. The aim is to find increasingly smaller regions within a tissue section to be scanned, because the scanning process for FISH (fluorescence in situ hybridization) samples is very slow and needs to be accelerated. After (co-)registration with a lower-resolution scan of the actual sample, the relevant (mIF) sample scan can be performed in the selected subregions of the tissue. In contrast, the purpose of these inventions is to automate the scanning process for all tissue samples, including (cyclic) staining processes. For this purpose, the individual staining steps of the same tissue are predefined, tracked, and appropriate scanning and other processes are triggered. Co-registration of the low-resolution pre-scan image with the subsequent image does not occur via the detection of common tissue features. Instead, the spatial reference is established via the stage coordinates, taking into account the inaccuracies in the stage controller. The images of the cyclically stained samples (from the same piece of tissue) are combined after the captures using a similar method to that in cited patent US 2003/0231791A, but with the intention of producing a combined image for spatial analysis.

However, automation of the spatial biological tissue analysis described above is not possible with the known methods and devices- or at best is only possible in certain aspects.

Against this background, the object of the invention is to provide a method and a device with which the aforementioned disadvantages can be at least partially eliminated. Ideally, a method would be developed that integrates as seamlessly as possible into the standard routine procedures of histopathology. Preferably, the overall process is to be at least partially automated and the number of necessary manual interventions reduced.

This object is achieved by the subject matter of the independent claims. The dependent claims concern specific embodiments.

A first aspect of the invention relates to a computer-implemented method for spatial analysis of stained biological samples-for example, cyclically stained biological samples.

Computer-implemented means that at least one method step, preferably multiple or all method steps, are carried out using a computer program.

Spatial analysis of biological samples is also known as spatial biology tissue analysis. Spatial biology encompasses the two-or three-dimensional analysis of biologically relevant molecules (e.g., proteins, DNA, RNA) in the spatial context of tissue (cell, cellular structure, organ). The term “spatial” therefore refers here to two-dimensional or three-dimensional space. Using methods of spatial biology, molecules can, for example, be visualized in their specific context within the individual cell or tissue. For example, fluorescence imaging and other methods can be used to analyze molecular expression at the single-cell and subcellular levels. This can help to understand the expression in other cells within a tissue.

The term “biological sample” as used here encompasses any sample containing a biomolecule, e.g., a protein, a peptide, a nucleic acid, a lipid, a carbohydrate, or a combination of the aforementioned substances, wherein the sample may be obtained, for example, from any organism, including viruses. A sample can, for example, be a tissue sample, such as a tissue section or a needle biopsy of tissue, or a cell sample, such as a cytological smear like a Pap smear or blood smear. Other examples of biological samples include blood, serum, urine, semen, feces, cerebrospinal fluid, interstitial fluid, mucous membrane, tears, sweat, pus, biopsied tissue, nipple aspirates, cerumen, milk, vaginal fluid, saliva, and smears. The term “sample” can also refer to a sample that has been taken from a tumor or part of it. Preferably, the sample can be a tissue sample. For analysis, the sample is usually placed on a microscope slide.

The term “stained sample” refers to a sample in which one or more components, e.g., proteins, are stained using one or more dyes, e.g., fluorescent dyes.

The term “cyclically stained sample” here means that the sample is stained with different dyes in a sequence and images are taken under a microscope, e.g., as part of repeated histological staining of the entire sample. For example, in a first cycle or round, multiple proteins of the sample can be stained at once or in multiple substeps. Then, at least one image is recorded. This concludes the first cycle. If another cycle is to be carried out, the previous staining is removed from the sample and then the entire process is repeated with new markers or dyes including image recording. In this way, any number of cycles can be carried out. In the simple case, a cyclically stained sample undergoes a single cycle. A cyclically stained sample preferably undergoes multiple cycles.

The proposed method involves the following method steps: identifying a sample; selecting an analysis routine from a plurality of analysis routines for the identified sample, wherein each analysis routine has a) a number n of subroutines where n>1, each subroutine comprising parameters of a scanning process in which at least one image of the entire sample is recorded, and b) parameters of an image analysis of the recorded images, applying the first to nth subroutines of the selected analysis routine to the identified sample, wherein the entire sample is scanned when each subroutine is applied, and evaluating the recorded images according to the parameters of the image analysis, wherein the evaluation of the recorded images comprises registering the images.

Optionally, the method can include recording of process parameters, such as device ID, details of the method protocols used, timestamps, user ID's, remaining manual steps performed by the user, and versions of software components used, for documentation purposes.

The steps of the proposed method can be carried out in the order mentioned, but also simultaneously, overlapping in time or in a different order, as required. For example, in a parallel analysis of multiple sequential tissue sections, one or more method steps can be performed simultaneously.

In the first method step, the sample is identified. For example, the sample can be arranged on a sample carrier, e.g., a microscope slide, which is marked with a code, such as a barcode, QR code, or the like, and is therefore uniquely assigned to the sample. In this case, identifying involves reading the code-for example, by scanning the code and comparing it with codes stored in a database. The code can preferably include a unique identifier (ID) of the sample, which can be used to call up the method steps assigned to that specific sample and optionally also to retrieve the processing status of the sample, e.g., which staining round is in progress, whether the pre-scan has already been performed, whether a repeat scan shall be performed due to insufficient image quality, etc. In other words, the sample can be assigned an ID that can be linked to stored automation parameters. Relevant sample parameters, e.g., identity of the staining, can also be obtained from external databases, e.g., retrieved.

The identified sample will then be processed according to the further steps of the proposed method.

It is also possible to identify multiple samples and select a specific sample from the plurality of the identified samples, which is then processed according to the further steps of the proposed method.

In the next method step, an analysis routine is selected for the previously identified sample from a plurality of different analysis routines, i.e., analysis routines that differ in at least one parameter. In other words, a specific analysis routine is assigned to the identified sample.

The term “analysis routine” can also be understood as assay and describe a standardized reaction sequence for the detection of a substance using a specific method, e.g., a molecular biological method.

Each analysis routine has a number n of subroutines where n>1, i.e., at least two subroutines. Each of these subroutines describes at least one scanning process in which at least one image of the entire sample is recorded, based upon parameters.

The term “image” here refers to a digital image of a sample or sample region. The term “recording” here encompasses the creation and storage of an image. The term “scanning” means that the sample is systematically sampled, viewed, or measured in order to obtain information or data, preferably in digital form. Scanning can preferably be done without contact.

The term “unit” as used herein refers to a hardware device and/or software configured to perform a specified function.

The term “storage unit” as used herein refers to a digital memory storage device.

The term “application” as used herein refers to a computer program embedded or implemented in hardware and/or software.

The term “routine” including “subroutine” as used herein refers to a set of instructions designed to perform a specified operation within or for a computer program.

The scanning can be performed, for example, as fluorescence scanning, in which the sample is irradiated with light of a specific wavelength and stimulated to emit fluorescence radiation. This fluorescence radiation can then be detected with spatial resolution.

Fluorescence images can preferably be captured as HDR images (high dynamic range image) to reduce or even avoid the need for manual adjustments to exposure times. In other words, a set of two or more individual images with multiple exposure parameter values can be captured and combined to create a high dynamic range microscope image. Over- and underexposure in the resulting image can be reduced as a result. This avoids the need to rescan a previously underexposed or overexposed region. This is particularly important for samples containing sensitive fluorophores, since these bleach easily. If a new exposure is necessary, the exposure parameters would otherwise need to be adapted to the now paler fluorescence. Contrast can also be lost, so that previously stained structures are no longer recognizable. For further details on the production of suitable HDR images, reference is made to DE10 2024 116 601 A1, the full disclosure of which is hereby incorporated into the present application by reference.

Optionally, the sample can be enlarged for scanning. In other words, scanning can be done, for example, using a fluorescence microscope.

Of course, scanning can also be done in bright field, e.g., as bright field microscopy, or in dark field, e.g., as dark field microscopy, or using other light microscopy methods.

In each subroutine, at least one image of the entire sample is recorded, i.e., generated and stored.

The parameters of the subroutine describe the subroutine and can, for example, specify which wavelength of fluorescence radiation shall be detected, which sample region shall be examined, which magnification shall be selected, which exposure duration shall be used, how many images shall be recorded, which camera settings shall be used for image recording, etc. Furthermore, the parameters of the subroutine can, for example, specify whether and, if so, which process-relevant parameters, such as when the sample was scanned, with which device the sample was scanned, and by which person the sample was scanned, shall be stored in a database.

In the case of multiple subroutines, the analysis routine can also specify or define a partial or complete sequence of the subroutines. For example, a specific sequence of the n subroutines can be defined, or it can simply be specified that a particular subroutine shall be executed before or after one or more other subroutines.

As part of the subroutines, a lower-resolution image of the entire slide (pre-scan) can first be generated, e.g., using a camera or a fast brightfield scan at low resolution, to find a suitable region for the actual sample scan. The aim here is to locate the region on the slide containing the sample, in order to save time during the subsequent scanning process of the sample scan, but also to be able to make the correct technical settings. This can include, on the one hand, the identification of regions by determining the exact focal plane using fluorescence or brightfield contrast on sample structures, and on the other, the identification of regions for determining, for example, white balance in the case of brightfield images. Determining the sample position of mIF-stained samples can be particularly difficult because the typically very thin samples have very low contrast and no inherent coloration visible in brightfield. Furthermore, other artifacts from sample preparation, such as air bubbles, fingerprints, and crumbs, appear with significantly higher contrast than the actual sample. While pre-scans using fluorescence are possible and offer better contrast, they are much slower and risk altering the sample due to premature fading of the fluorescent dyes. For particularly reliable detection of the sample regions despite the aforementioned problems, an AI (artificial intelligence) algorithm can be used, for example.

Pre-scans and sample recognition using AI algorithms can be used to reduce scan time on the one hand and to define relevant regions for focus finding on the other.

In addition to at least one subroutine, each analysis routine includes parameters for an image analysis of the recorded images. These parameters can, for example, specify which image content shall be evaluated and how, in the case of multiple recorded images within one or more subroutines, the recorded images shall be processed together.

The proposed method further involves applying the first to nth subroutine to the identified sample, wherein the entire sample is scanned during the application of each subroutine. In this process, at least one image is recorded for each subroutine according to the parameters of the scanning procedure of the respective subroutine.

Subsequently, the recorded images are evaluated according to the parameters of the image analysis, which are part of the analysis routine, in order to obtain spatial information about the sample. Evaluating the recorded images includes registering the recorded images. In other words, an image registration is performed.

Registration creates a new, uniform, and aligned image with different staining of the same sample, e.g., the same tissue section.

Any remaining manual intervention options in the scanning process, e.g., triggered by the visual inspection of the images of a subroutine, resulting in the need to rescan the same sample to produce a higher-quality scan result, can be recorded by the system, e.g., together with other relevant system events, in a separate database and securely assigned to the user and the results. This enables flawless documentation of work results, as is necessary in areas with high regulatory documentation requirements.

The proposed method enables the integration of spatial analysis of biological samples into standard routine procedures in histopathology. The number of necessary manual interventions can be significantly reduced, thus reducing the analysis effort, which can also contribute to cost reduction. Furthermore, automation, due to the computer-implemented execution of the method, enables a reduction in variability, so that reliable and reproducible analysis results can be obtained. The proposed method also supports the documentation required in routine laboratories. The proposed method proves particularly advantageous in the automated analysis of cyclically stained samples.

In contrast to the prior art known from US 2003/0231791 A, a main purpose of the proposed method is therefore to automate the scanning process for the entire tissue sample, including (cyclic) staining procedures. For this purpose, the individual staining steps of the same tissue are predefined, tracked, and appropriate scanning and other processes are triggered. (Co-)registration of the low-resolution pre-scan images with the subsequent image does not take place via the detection of common tissue features. Instead, the spatial reference is established via the stage coordinates, taking into account the inaccuracies in the stage controller. The images of the cyclically stained samples (from the same piece of tissue) can be combined after the captures using a similar method to that described in US 2003/0231791 A, but with the intention of producing a combined image for spatial analysis.

The following explains the registration of images in more detail.

Image registration, also sometimes referred to as registration or co-registration, is used to align multiple recorded images of the same sample region. The individual images may differ, for example, because they were taken with different sensors, e.g., multiple sensors, that detect (fluorescence) radiation of different wavelengths, or because they were taken from different positions.

For image registration, for example, one of the images can be set as a reference image to which the other recorded images are adapted. The aim here is to obtain a single overall image that combines as much image information as possible from the recorded images. This allows for a detailed spatial analysis of the sample. For example, the images can be superimposed with nearly pixel-to-pixel accuracy, so that the overall image simultaneously reproduces, for example, all stains performed within the subroutines.

To register two or more images, it is necessary to know, firstly, where the images are stored and, secondly, which stain was used for which image. For example, if multiple fluorescently stained images are to be registered, a channel is needed that is present or shared in all images. While such a channel is also required for brightfield images in principle, since there are always three RGB channels in this case, normally, nothing further needs to be configured.

Normally, different registration algorithms are needed for RGB and mIF images, just as they are for registering an mIF image with a brightfield image. With the available information, e.g., staining method, marker name, image storage path, these algorithms can be selected and, if necessary, parameters can be determined.

Preferably, images of the same resolution can be registered together during registration, and a single image can be created. Preferably, registration can be based upon image features that are present in all images.

Image registration can take place after applying the nth subroutine and/or before applying the nth subroutine, in other words, after completion of all subroutines based upon the entirety of the recorded images and/or also between subroutines of the selected analysis routine.

Image registration after completion of all subroutines has the advantage that all images are used for image registration and the image registration can be optimized for all images. The overall computational effort can be reduced compared to interim image registration.

An interim image registration after the completion of only a few subroutines has the advantage that newly recorded images can be immediately checked for compatibility or agreement with the previous images. Should it turn out that a newly recorded image is incompatible or unsuitable, the image recording can be repeated. This can improve the quality of the analysis.

According to various embodiment variants, the sample can be re-identified before applying the second, and each subsequent, subroutine. A subroutine to be applied can then be selected for the newly identified sample.

The subroutine can be re-identified in the same way as the initial identification of the sample described above. After re-identification, it can be determined, e.g., by a database comparison, whether and, if applicable, which subroutines of the selected analysis routine have already been applied to the re-identified sample. Based upon this, the next subroutine to be applied can then be determined, which is then subsequently applied to the sample.

Re-identification can help ensure, especially when analyzing multiple samples in parallel or overlapping time, that the correct subroutine is always selected and applied, and that recorded images are assigned to the correct sample. Furthermore, the process documentation can be more detailed and reliable.

According to further embodiment variants, the evaluation of the recorded images can include automated quality control.

For example, quality control of the generated images can be automated as part of the process routine, e.g., by executing an AI algorithm that detects, for example, blurry image regions or other artifacts. As a result, the system can either alert the user to any problems found, (and) interrupt the scanning process, or automatically initiate a new scan with adapted parameters. Such quality control can also be implemented as a parameter of a scanning process in a subroutine within the proposed method.

Automated quality control can further improve the reliability of automated spatial analysis of biological samples.

According to various embodiment variants, the parameters of a subroutine can be selected from a group comprising a type of staining, a designation of a stained biomarker, a designation of a fluorophore used for staining, and a color for a display of a staining.

The term “staining” here generally refers to any treatment of a biological sample that detects and/or differentiates the presence, location, and/or quantity of a particular molecule, e.g., a lipid, protein, or nucleic acid, or a particular structure, such as the cytosol, nucleus, Golgi apparatus, or cytoskeleton of a normal or malignant cell, in the sample. For example, staining can create a contrast between a particular molecule or cellular structure and surrounding parts of a biological sample, and the intensity of the staining can provide a measure of the amount of a particular molecule in the sample. Staining can be used to aid the viewing of molecules, cellular structures, and organisms not only with bright-field microscopes, but also with other viewing tools such as phase contrast microscopes, electron microscopes, and fluorescence microscopes. Examples of staining methods include histochemical methods, immunohistochemical methods, and other methods based upon reactions between molecules, such as hybridization reactions between nucleic acid molecules. Staining can be performed, for example, as chromogenic staining, i.e., with a dye that develops a specific stain when bound to a target, e.g., a biomarker, or as fluorescence staining. Fluorescence staining uses fluorescent compounds or fluorophores for staining, which emit fluorescent radiation when irradiated with light of a specific wavelength, and this radiation can be detected.

The term “biomarker” here refers to a characteristic biological feature that can be objectively measured. Examples of biomarkers include cells, genes, gene products, enzymes, and hormones.

The parameters of a subroutine can, for example, specify whether a chromogenic or fluorescent stain shall be used as the type of stain, e.g., determining whether a chromogenic or a fluorescent stain shall be analyzed in the associated scan process. Alternatively or additionally, a label, e.g., a name, of a stained biomarker can be specified as a parameter of a subroutine. Alternatively or additionally, in the case of fluorescence staining, a designation, e.g., a name, of a fluorophore can be specified as a parameter of a subroutine. Finally, a desired display color of a stain, e.g., in the recorded image, can be specified as a parameter of a subroutine.

According to various embodiment variants, the method can involve creating an analysis routine by selecting subroutines.

In other words, the proposed method can involve not only simply selecting a specific analysis routine from a plurality of analysis routines, but it can also involve first creating an analysis routine from a number n of subroutines where n>1, wherein each subroutine includes parameters of a scanning process in which at least one image is recorded.

This has the advantage that not only can existing analysis routines, e.g., those stored in a data bank, be used, but also that further analysis routines can be created to address specific requirements of the sample. Consequently, the scope of application of the proposed method can increase.

The function of creating analysis routines may, for example, be or become available in an advanced user mode (expert mode) or require special authorization. This largely prevents the unintentional and/or faulty creation of analysis routines.

The selection of subroutines for creating an analysis routine can be done using non-configurable parameters, configurable parameters, and/or automatically configured parameters.

The non-configurable parameters can, for example, be selected from a group including parameters for performing a pre-scan, parameters for performing a sample scan, focusing parameters, and parameters for image recording.

The term “non-configurable parameter” refers to a parameter that cannot be changed, and is permanently fixed. The non-configurability prevents any intentional or unintentional modification of these parameters. This can contribute to improved reproducibility and higher analysis quality.

The non-configurable parameters can, for example, describe pre-optimized, generic scan protocols that can be used to scan, for example, fluorescently and/or chromogenically stained tissue sections.

Alternatively or additionally, non-configurable parameters can be used to define a pre-scan, i.e., a scan performed before the actual scanning process, which is usually faster than the actual scanning process, in order to, for example, first gain an overview of the sample and subsequently be able to select sample regions of interest. For example, the pre-scan can be used to support the automatic detection of sample regions to be scanned, e.g., tissue regions.

Non-configurable parameters can also define focusing strategies and/or parameters of an image recording, e.g., the use of HDR imaging, binning, image compression, etc. The term “binning” refers to the combining of adjacent image elements or pixels, which can achieve a higher light sensitivity per virtual pixel and increase the signal-to-noise ratio.

The configurable parameters can, for example, be selected from a group comprising a biomarker, an assignment of a biomarker to a staining process, an exposure time, and a name of a storage location where the recorded image(s) will be stored.

The term “configurable parameter” refers to a parameter that can be adjusted or selected, e.g., by a user or operator of the method, a service technician, maintenance engineer, or another person. The configurability of parameters has the advantage that they can be individually adapted to specific requirements and/or conditions—for example, to a specific sample. This can improve the quality of the analysis.

Preferably, it can be provided that the configurable parameters not be configured for each individual recording or image, but only a few times or even just once for a specific protocol, which can then be repeatedly applied without further configurations, e.g., to new samples.

For example, configurable parameters can be used to select one or more biomarkers that support visual and/or automated analysis. Furthermore, configurable parameters can be used to assign biomarkers to staining rounds and, for example, to define an algorithm for analyzing the biomarkers to be analyzed. Furthermore, the exposure time can be varied as a configurable parameter, which can enable better image quality. Furthermore, the name of the folder in which the recorded images are stored can also be selected, thus influencing the storage behavior.

It may also be provided that certain parameters be configurable only for specific user groups. In a standard mode of the method, for example, it may be provided that only existing analysis routines and/or subroutines be able to be selected and/or executed, but no new routines be able to be added. In standard mode, triggering certain steps may be optionally permitted, e.g., assessing image quality, retriggering a scan, etc. In contrast, an expert mode of the method may, in addition to the functions of the standard mode, allow for the definition of new analysis routines and/or subroutines.

In other words, different user roles, e.g., simple user, expert, etc., can be defined, wherein different permissions can be assigned to these user roles.

The automatically configured parameters can, for example, be selected from a group comprising parameters of an optimized scanning process, such as depending upon a type of staining including the selection of a, preferably the most suitable, algorithm for automatic tissue recognition, parameters of an image analysis, e.g., based upon the specified biomarkers, and parameters to describe file storage locations of recorded images that are to be registered.

The term “automatically configured parameter” refers to a parameter that is in principle configurable or selectable, wherein the configuration or selection is carried out automatically by the analysis system, e.g., a control unit of the analysis system, based upon user specifications. Automatic configuration can be based, for example, upon routines stored in the control unit. The automatic configuration of parameters has the advantage that they can be individually adapted to specific requirements and/or conditions—for example, to a specific sample. However, automation can prevent incorrect user input. Overall, the quality of the analysis and the reproducibility of the analysis results can be increased.

For example, parameters can be automatically configured by assigning an analysis algorithm or parameters of such an algorithm to each biomarker to be analyzed. After each biomarker is initially analyzed separately, the results are then combined to select suitable subroutines and create the analysis routine.

According to various embodiment variants, the method can involve exchanging data with a laboratory information management system and/or an image management system.

The term “laboratory information management system,” abbreviated LIMS system, refers here to an application for managing data and supporting workflows in a laboratory. Preferably, a LIMS system can enable reliable sample tracking.

The term “image management system,” abbreviated IMS system, refers here to an application for the organization, centralization, distribution, and optional storage of digital images.

Data exchange can help to improve and make more efficient the integration of the proposed method into laboratory workflows. If data exchange is automated, user-caused errors can also be avoided.

Furthermore, the method can include the automated sending of notifications, e.g., in the form of emails, text messages, or an app notification, to laboratory technicians. This can help to alert these individuals to a successful completion of the scanning process or to errors in the scanning process.

A further aspect of the invention relates to an arrangement for spatial analysis of (cyclically) stained biological samples.

The proposed arrangement may, for example, be suitable for carrying out the method described above. Therefore, the above explanations of the method for spatial analysis of biological samples also serve to describe the proposed arrangement. The proposed arrangement brings with it the corresponding advantages of the method.

The proposed arrangement has: an identification device designed to identify a sample; a first data bank containing a plurality of analysis routines, each analysis routine having a) a number n of subroutines where n>1, each subroutine comprising parameters of a scanning process in which at least one image is recorded, and b) parameters of an image analysis of the recorded images; a control unit configured to select an analysis routine from the plurality of analysis routines of the first data bank based upon an identity of the sample; an image generation device configured to generate images of the entire sample according to the parameters of the scanning processes of the n subroutines; a storage unit configured to store the generated images, and an evaluation unit configured to evaluate the stored images according to the parameters of the image analysis, wherein the evaluation of the recorded images includes registering the images.

The devices, units, banks, etc., of the arrangement can be physically designed as one or more parts. Integration of multiple devices, units, banks, etc., is also possible. For example, the evaluation unit, storage unit and control unit can form the same component and/or be integrated into each other. Furthermore, the data bank can also be stored in the storage unit. Finally, the identification device can be integrated into the image generation device. Further ways of combining the devices, units, banks, etc., mentioned here are possible.

The identification device serves to identify the samples, e.g., using a barcode, QR code, or the like. Accordingly, the identification device can be designed, for example, as a code scanner for reading a code, e.g., as a so-called slide scanner. Optionally, the identification device can be equipped for automatic text recognition, i.e., it can include, for example, a so-called OCR (optical character recognition) module.

The first data bank, which can be understood, for example, as an analysis routine database, serves to store analysis routines. Optionally, subroutines can also be stored, so that an analysis routine can be created by selecting subroutines and then also stored in the first data bank. The term “data bank” or database here refers to an organized collection of data that are stored in digital form on a computer, a server, in a cloud, or the like.

The control unit of the arrangement can be implemented in hardware and/or software and can be physically designed as a single or multiple part. The control unit serves to select an analysis routine for the identified sample, either partially or fully automatically. In other words, the control unit assigns a specific analysis routine from the first data bank to the identified sample. Optionally, the control unit can also be used to recreate an analysis routine by selecting subroutines.

The image generation device can, for example, be designed as a camera. Preferably, the image generation device can be integrated into a microscope, e.g., a fluorescence microscope. Images of the sample can be generated using the image generation device. The image generation device can preferably be configured to detect colorations of the sample and to generate corresponding images. For example, the image generation device can be designed to detect fluorescence radiation, e.g., as a fluorescence scanner.

The arrangement includes a storage unit for storing the images generated by the image generation device. For this purpose, the storage unit has an operational connection with the image generation device, based upon signal transmission.

The evaluation unit allows the stored images to be evaluated according to the parameters of the image analysis. The evaluation unit can be specifically designed to register multiple stored images. Optionally, the evaluation unit can be provided with the ability to access process-relevant parameters from external databases, e.g., a database of a LIMS system, so that, for example, images and metadata can be transferred.

Optionally, the arrangement can include a user interface. The term “user interface” here refers to a point or action that enables a user, e.g., histologists, cytologists, pathologists, etc., to interact with the arrangement, e.g., to transmit commands and data to the arrangement and to obtain results. The user interface can, for example, include a graphical user interface. The user interface allows the user to, for example, configure parameters, view data, receive evaluations, etc.

According to various embodiment variants, the arrangement can include a second data bank. The second data bank, which can be understood, for example, as a sample database, serves to store sample information.

The data stored in the second data bank can be used, for example, to track the subroutines or work steps performed for each sample. This allows the documentation and continuation of the analysis routine to be supported with the correct subroutine.

The second data bank can have an operational connection with the identification device based upon signal transmission, so that data from the second data bank can be assigned to the identified sample and/or data about the identified sample can be stored.

Optionally, in addition to the first data bank or in addition to the first and second data banks, a further data bank may be available for the tamper-proof storage of the relevant parameters of the analysis process, checksums for the generated images, and/or profiles of users who perform or have performed relevant steps.

According to further embodiment variants, the arrangement can include a handling device designed for handling the sample.

Preferably, the handling device can be designed for automated handling of the sample, e.g., as a handling robot. For this purpose, the handling device can have an operational connection with the control unit based upon signal transmission.

The handling device enables automated sample handling, allowing sample analysis to be performed with a high degree of automation. This can prevent erroneous and/or fluctuating analysis results that may result from varying or incorrect sample handling by a user.

According to further embodiment variants, the arrangement can include a staining device designed to stain the sample, preferably according to the selected analysis routine.

The staining device can preferably be designed for automated sample staining. The staining device allows staining routines to be carried out partially or fully automatically, thus achieving higher reproducibility of the staining. Furthermore, automating the staining routine can help reduce the time required to perform the staining routine, thus enabling higher sample throughput and increased analysis efficiency.

According to further embodiment variants, the arrangement can have an interface to a laboratory information management system and/or an interface to an image management system.

The interface to the respective systems enables an improvement in the integration of the proposed arrangement into a laboratory environment. Preferably, the images and analysis results generated by the arrangement can be automatically transferred to a laboratory information management system and/or image management system. It may also be possible to transfer data from the laboratory information management system or image management system to the arrangement. This eliminates the need for time-consuming and error-prone manual data transfer.

For example, the analysis routines performed and planned can be documented in a laboratory information management system, and/or recorded images can be stored in an image management system.

Optionally, the laboratory information management system and/or the image management system can be part of the proposed arrangement and may further optionally integrate one or more components of the arrangement. For example, the storage unit of the arrangement can be part of the image management system.

A further aspect of the invention relates to a computer program. The computer program includes commands that cause the proposed arrangement to execute the proposed method.

Therefore, the above explanations of the method and arrangement also serve to describe the proposed computer program. The proposed computer program accordingly combines the advantages of the method and the arrangement.

A computer program can be understood as program code that can be stored on a suitable medium and/or retrieved via a suitable medium. Any medium suitable for storing software can be used to store the program code-for example, non-volatile memory built into a control unit, a DVD, a USB stick, a flash card, or the like. The program code can be retrieved, for example, via the Internet or an intranet, or via another suitable wireless or wired network.

Further aspects of the invention relate to a computer-readable medium on which the computer program is stored and a data carrier signal that transmits the computer program.

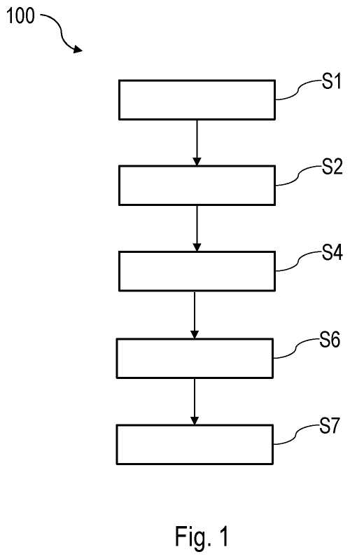

The invention is explained below by way of example with reference to the accompanying figures and preferred embodiments, wherein the features shown below can represent an aspect of the invention both individually and in various combinations with one another, wherein:
FIG. 1 is a flowchart of an example of a method for spatial analysis of biological samples,

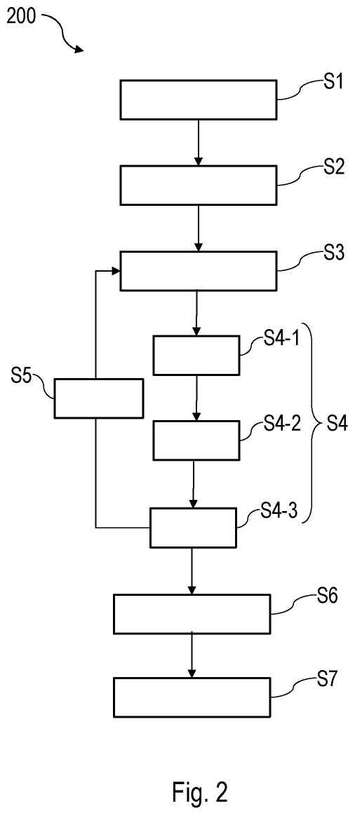

FIG. 2 is a flowchart of a further example of a method for spatial analysis of biological samples, and

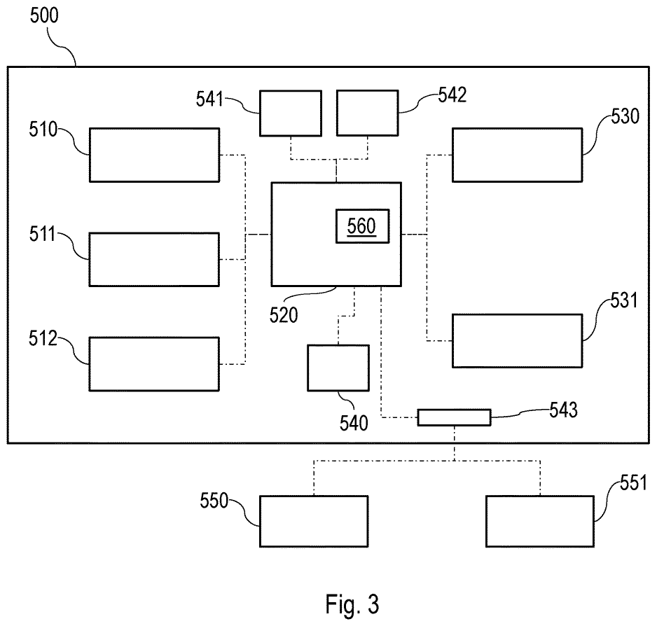

FIG. 3 is a schematic illustration of an example of an arrangement for spatial analysis of biological samples.

FIG. 1 is a flowchart of a computer-implemented method 100 according to a first exemplary embodiment, with which biological samples can be analyzed with spatial resolution. The method 100 can, for example, be carried out using the arrangement 500 shown schematically in FIG. 3.

In the simplest case, the method 100 can be started or triggered by a user by a corresponding input on a user interface 560 of the control unit 520, after the user has placed slides with barcodes, each containing a sample, into a slide scanner.

In the first method step S1, the sample is identified. For this purpose, the barcode of the slide on which the sample is located can be read using the slide scanner as an identification device 510.

Subsequently, in method step S2, the control unit 520 selects for the identified sample an analysis routine from a first data bank 511, which is to be applied to the identified sample. The analysis routine has multiple subroutines that are performed sequentially, and also image analysis parameters with which the images of the sample recorded during the subroutines are evaluated. Each of the subroutines includes parameters of a scanning process in which at least one image is recorded, i.e., generated and stored. For example, a subroutine can be performed for each biomarker for which the sample is to be tested. In other words, a scanning process can be performed for each biomarker, the parameters of which are adapted to the biomarker being analyzed and the staining used for this purpose.

In the next method step S4, the subroutines of the selected analysis routine are applied to the entire identified sample according to the time sequence contained in the analysis routine. In each subroutine, an image of the entire sample is generated using the image generation device 530 and stored using the storage unit 540.

After all subroutines have been carried out, the stored images are evaluated using the evaluation unit 531 in method step S6. The evaluation process involves registering the images, i.e., from multiple, preferably all, stored images, a single image, the registered image, is created, which represents the image information of the individual images in a collected form and thereby simplifies the analysis of the image information. For registration, the stored images can be retrieved from the storage unit 540. The registered image can then be stored in the storage unit 540.

The image evaluation is carried out according to the parameters of the image analysis, which are part of the applied analysis routine. In other words, the analysis routine defines the image analysis algorithm.

Image registration can be started by the control unit 520 after completion of the last subroutine by transmitting the storage locations of the stored images, the names of the detection channels, e.g., for a specific fluorescent dye, and the types of staining to the evaluation unit 531. For example, the image(s) recorded in the first subroutine can be set as the reference image(s). The image(s) recorded in the subsequent subroutines can then be adapted to the reference image(s), e.g., by shifting, stretching, compressing, etc. Optionally, depending upon the type of image, different channels can also be used to find common image information that can be used for the registration process. For example, fluorescently stained images can be aligned using the nuclear staining channel. In chromogenically stained images, the nuclear staining can be extracted using other methods, e.g., color deconvolution. Furthermore, the newly generated, registered image can be supplemented with relevant metadata during the registration process, e.g., with the names of the biomarkers and fluorophores and the imaging rounds per channel.

To support the documentation process and improve integration into existing laboratory workflows, the method 100 can optionally provide for data exchange with a connected laboratory information management system 550 and/or image management system 551 in method step S7.

For example, performed and planned analysis routines and subroutines can be documented in a laboratory information management system 550. The control unit 520 can use this information to retrieve the planned analysis routine or subroutines, possibly together with supporting metadata, for each sample, and to report back the progress of the routines performed as well as the results or links to the results. Similarly, the control unit 520 can send images and supporting metadata to an image management system 551 and, if necessary, trigger the execution of the image analysis and receive information about the analysis progress, which can then be passed on to the laboratory information management system 550.

FIG. 2 is a flowchart of a further exemplary embodiment of a method 200 for spatial analysis of biological samples, which is more complex than the method 100 described with reference to FIG. 1.

In this method 200, analogously to the method 100 described with reference to FIG. 1, the sample is first identified in method step S1 and an analysis routine is selected in method step S2.

Before applying the subroutines in method step S4, method step S3 checks how often the sample has already been scanned or which subroutines have already been applied to the sample in order to select the next subroutine to be performed and to determine the associated parameters of the scanning process, and set them for applying the subroutine. For example, for a sample that has never been scanned, the parameters for applying the first subroutine are selected, while for a sample that has already been scanned, parameters for applying the second subroutine are selected, etc.

The application of the respective subroutines in method step S4 then includes generating an image of the sample (method step S4-1), saving the generated image (method step S4-2), wherein the image file is stored in a predefined location, and documenting the applied subroutine as well as the progress of the multi-stage analysis routine for later use (method step S4-3). In particular, the location of the saved file and the scanned biomarkers is stored to support the subsequent registration process, as is information on how many more images need to be scanned before the registration process can be triggered.

The method steps S3 and S4 with the substeps S4-1 to S4-3 are then repeated for all further subroutines including the nth subroutine. Optionally, the sample is re-identified before applying the next subroutine in method step S5, e.g., analogously to method step S1, and method step S3 is then carried out again for the re-identified sample.

As already mentioned, the methods 100, 200 of the first and second exemplary embodiments can be carried out using the arrangement 500, which is shown schematically in FIG. 3.

FIG. 3 schematically shows the components of the arrangement 500 and their links. Here, signal-based operational connections are represented by a dash-dot line.

The arrangement 500 has a control unit 520 with a user interface 560, by means of which a user of the arrangement 500 can make inputs, e.g., specify parameters, assign names, etc. Preferably, the user interface 560 is designed to be as simple as possible, i.e., it has only a few, e.g., 2 to 3, operating elements or operating symbols. It can also generate an automated pre-selection and/or a suggestion for further steps. Preferably, a menu or wizard with many parameters can be dispensed with in order to enable robust use, e.g., also by less trained users.

The control unit 520 can also be considered a workflow manager, which provides workflow logic for connecting and controlling the other components of the arrangement as well as upstream and downstream systems that are relevant for the analytical workflow, e.g., LIMS, IMS, and image analysis systems.

The arrangement 500 further includes an identification device 510 and an image generation device 530, both of which have an operational connection with the control unit 520 based upon signal transmission. This means that the control unit 520 can generate control signals and output them to the identification device 510 or the image generation device 530 to control them-for example, to make them identify a sample or generate an image.

Furthermore, the control unit can access a first data bank 511, in which analysis routines are stored, and a second data bank 512, in which sample information is stored. Using the second data bank 512, the work steps performed for each sample can be documented, and the documentation and continuation of the analysis routine with the correct subroutine can be supported, which is particularly important for cyclic staining and imaging routines, to obtain high-quality, reliable analysis results.

Furthermore, there is also an operational connection between the control unit 520 and a storage unit 540 as well as an evaluation unit 531, based upon signal transmission. The interface 543 allows data to be exchanged with a laboratory information management system 550 and an image management system 551.

Optionally, the arrangement 500 can be equipped with a handling device 541 and/or a staining device 542, which can also be controlled by means of the control unit 520.

For example, an automated staining device 542 for samples can be connected to the control unit 520 in a similar way to the slide scanner. Based upon the stored analysis routines, the control unit 520 of such a staining device 542 can provide the necessary inputs for an automatic staining run. The staining device 542 can optionally be configured to identify the loaded slides using the existing barcode and to execute a predefined staining routine.

The described methods and arrangements contribute to a simplification of existing workflows by enabling method steps to be carried out according to predefined or predefinable routines. This makes the analysis less prone to errors and allows for high-quality and reproducible analysis results.

The expression “and/or” used here, when used in a series of two or more elements, means that each of the listed elements can be used alone, or any combination of two or more of the listed elements can be used. For example, if reference is made to a series A, B, and/or C, then A alone; B alone; C alone; A and B in combination; A and C in combination; B and C in combination; or A, B, and C in combination may be affected.

### LIST OF REFERENCE SIGNS

100 method
S1 identifying the sample
S2 selecting an analysis routine
S3 selecting a subroutine
S4 applying the subroutines
S4-1 generating an image of the sample
S4-2 saving the generated image
S4-3 documenting the applied subroutine
S5 re-identifying the sample
S6 evaluating the recorded images
S7 exchanging information with a laboratory information management system and/or an image management system
200 method
500 arrangement
510 identification device
511 first data bank
512 second data bank
520 control unit
530 image generation device
531 evaluation unit
540 storage unit
541 handling device
542 staining device
543 interface
550 laboratory information management system
551 image management system
560 user interface

1. A computer-implemented method for spatial analysis of stained biological samples, the method comprising:
identifying a sample,
selecting an analysis routine from a plurality of analysis routines for the identified sample, wherein each analysis routine has a) a number n of subroutines where n>1, each subroutine comprising parameters of a scanning process in which at least one image of the entire sample is recorded, and b) parameters of an image analysis of the recorded images,
applying the first to nth subroutine of the selected analysis routine to the identified sample, wherein the entire sample is scanned when applying each subroutine, and
evaluating the recorded images according to the parameters of the image analysis, wherein the evaluation of the recorded images includes registering the images.

2. The method according to claim 1, wherein the sample is re-identified before applying the second and each subsequent subroutine, and a subroutine to be applied is selected for the re-identified sample.

3. The method according to claim 1 wherein the evaluation of the recorded images comprises automated quality control.

4. The method according to claim 1, wherein the registration of the images takes place after applying the nth subroutine and/or before applying the nth subroutine.

5. The method according to claim 1, wherein the parameters of a subroutine are selected from a group comprising a type of staining, a designation of a stained biomarker, a designation of a fluorophore used for a staining, and a color for a display of a staining.

6. The method according to claim 1, comprising:
creating an analysis routine by selecting subroutines.

7. The method according to claim 6, wherein the selection of the subroutines is based upon non-configurable parameters, configurable parameters, and/or automatically configured parameters.

8. The method according to claim 1, comprising:
exchanging data with a laboratory information management system and/or an image management system.

9. An apparatus for spatial analysis of stained biological samples for performing the method of claim 1, the apparatus comprising:
an identification device designed to identify a sample,
a first data bank containing said plurality of analysis routines, wherein each analysis routine has a) a number n of subroutines where n>1, each subroutine comprising parameters of a scanning process in which at least one image is recorded, and b) parameters of an image analysis of the recorded images,
a control unit designed to select an analysis routine from the plurality of analysis routines of the first data bank based upon an identity of the sample,
an image generation device configured to generate images of the entire sample according to the parameters of the scanning processes of the n subroutines,
a storage unit designed to store the generated images, and
an evaluation unit designed to evaluate the stored images according to the parameters of the image analysis, wherein the evaluation of the recorded images comprises registering the images.

10. The apparatus according to claim 9, comprising:
a second data bank, containing sample information.

11. The apparatus according to claim 9, comprising:
a handling device designed for handling the sample.

12. The apparatus according to claim 9, comprising:
a staining device designed to stain the sample.

13. The apparatus according to claim 9, comprising:
an interface to a laboratory information management system and/or an interface to an image management system.

14. A computer program product comprising at least one computer readable storage medium readable by a processing unit and storage instructions for performing the method of claim 1.

15. The method according to claim 3, wherein the registration of the images takes place after applying the nth subroutine and/or before applying the nth subroutine.

16. The method according to claim 15, wherein the parameters of a subroutine are selected from a group comprising a type of staining, a designation of a stained biomarker, a designation of a fluorophore used for a staining, and a color for a display of a staining.

17. The method according to claim 16, comprising:
exchanging data with a laboratory information management system and/or an image management system

18. The apparatus according to claim 10, comprising:
a handling device designed for handling the sample.

19. The apparatus according to claim 18, comprising:
a staining device designed to stain the sample.

20. The apparatus according to claim 19, comprising:
an interface to a laboratory information management system and/or an interface to an image management system.
